(19) United States
(12) Patent Application Publication
(10) Pub. No.: US 2009/0158035 A1
(43) Pub. Date: Jun. 18, 2009

(54) Public Key Encryption For Web Browsers

(76) Inventor: John G. Stultz, Portland, OR (US)

Correspondence Address: LIEBERMAN & BRANDSDORFER, LLC, 802 STILL CREEK LANE, GAITHERSBURG, MD, 20878, US

(21) Appl. No.: 11/955,578

(22) Filed: Dec. 13, 2007

(51) Int. Cl. H04L 9/06

(52) U.S. Cl. 713/160

(57) ABSTRACT

A method, apparatus, and article are provided to support encryption of web service applications on a remote server. In a computer system with a remote server and a local client machine, a browser is provided on the local client machine to access applications on the server. Web server applications are stored on one or more remote servers, with access provided through the browser local to the client machine. A user of one or more web services may encrypt data entered with a public key, and may view received data with a private key. The public key and private key are local to the client machine and are employed to encrypt the data stored on the server.

### BACKGROUND OF THE INVENTION

1. Technical Field

This invention relates to encryption of data transmitted across a network of interconnected servers and client machines. More specifically, the invention relates to applying encryption techniques to data entered in a service application stored on a server through a browser on a client machine.

2. Description of the Prior Art

Electronic mail communication is becoming an accepted avenue of communication for many businesses today. Although it has not replaced the need for oral communication, it certainly functions as a tool for fast written communication and transfer of documents. Along with the growth of electronic mail communication, there is the growth of individuals who search the Internet to intercept electronic mail communication that contains private or otherwise confidential information. Without some form of encryption, a skilled hacker can intercept the message and any associated attachments and read the non-protected information in the message.

There are various forms of encryption. One of the known tools is called symmetric cryptography which employs a symmetric key, i.e. the same key, to encrypt and decrypt. The symmetric key requires only one password for both encryption and decryption. Another tool that has become popular for encryption of electronic mail communication is known as public key cryptography, also known as asymmetric cryptography. A user in the public key cryptography system has a pair of cryptographic keys, a public key and a private key. The public key may be widely distributed and a private key is known only to the recipient of the message. The keys are mathematically related so that only the public key can be used to encrypt messages and only the corresponding private key can be used to decrypt them. Employment of the symmetric key or the public key cryptography does require obtaining one or more keys from an authorized vendor, and for appropriately distributing and maintaining the keys on a computer storage medium. More specifically, a message which a sender encrypts using the recipient's public key can only be decrypted by the recipient's paired private key. At the same time it is virtually impossible to deduce the private key from a known public key. The use of the public key private key encryption system is to ensure confidentiality of the content of the electronic mail message.

There are two primary electronic mail services available through the Internet. One of the services is accessed via a web browser, which is known as web mail, and the second of the services is accessed through an application resident on the computer. The advantage of a web mail service is that it resides on a remote server and is not stored locally on a client machine. A user has the ability to access their inbox from any Internet connected computer. At the same time, a disadvantage of the web mail service is that a user cannot access old messages or work on new messages unless the computer they are using is connected to the Internet. In addition, the user of the web mail needs to trust the web service provider with the information provided by the user. Features such as end to end encryption of electronic mail are not possible due to the fact that the application lives on a remote server and not on a browser local to the client. Accordingly, if encryption is a concern to the user, the web mail service may not be the optimal electronic mail communication service.

In a similar manner to the web mail based application, there are other electronic tools that are available for use on the Internet that function in a similar manner. For example, there is an electronic calendar available that allows a user to enter and track calendar information on-line. In a similar manner to the web mail, the user of the calendar would have an account with a user identifier and an associated password to access their calendar account. Like the web mail, the on-line calendar resides on a remote server and is not stored locally on the client machine. Accordingly, the calendar form of web services requires the user to trust the web service provider with the information provided in relation to the account.

Accordingly, as demonstrated there are various web based tools and services available to users with each of these tools having limitations associated with encryption of data. The basis for the limitations is that the data is maintained in a web application in a remote server and not by a local application. Currently, if a user wants to send public key mail using a web mail service, the user would have to encrypt the data with a tool into a file, and copy and paste the encrypted data into the text field in the web application. When viewing the page with the encrypted text, the recipient would have to copy and paste the data out of the web browser into a file and use a separate tool to decrypt the data. A similar procedure would have to be followed with use of a calendaring tool or any other web application wherein the data resides on a remote server.

Accordingly, there is a need for a tool that would support encryption of data in relation to a web hosted application that resides on a remote server. The tool would support the continued use of web based applications such as web mail, web calendar, etc., and at the same time the tool would support encryption of the data entered into the web based application in a local manner.

### SUMMARY OF THE INVENTION

This invention comprises a method, apparatus, and article of manufacture to support encryption of data employed with a web service application.

In one aspect of the invention, a method is provided for encrypting data across a computer network. A distributed computer system is configured with at least one client machine in communication with at least one server machine across the network. Access to a service application is supported by the server machine through a browser that is local to one of the client machines. Data is entered into at least one field in the service application through the browser, and the entered data is encrypted on one of the client machines with a public key. The encrypted data is transmitted to and received by the server. The received encrypted data is decrypted with a private key local to one of the client machines in receipt of the data.

In another aspect of the invention, a computer system is provided with at least one client machine in communication with at least one server machine across a network. A service application is provided and supported by the at least one server machine, and a browser is provided and operable on the at least one client machine. The service application is accessible through the browser. An input device is provided to communicate with the browser and to facilitate and accommodate data entry into at least one field in the service application through the browser. To encrypt the entered data, an encryption manager is provided in the browser on one of the client machines with a public key. A communication protocol is provided to transmit the encrypted data to the server machine. One of the client machines is configured to receive the encrypted data from the server machine, and the encryption manager decrypts the received encrypted data with a private key local to the client machine in receipt of the data.

In yet another aspect of the invention, an article is provided with a computer readable carrier including computer program instructions configured to encrypt data. Instructions are provided to configure a distributed computer system with at least one client machine in communication with at least one server machine across a network. In addition, instructions are provided to access a service application supported by the server machine through a browser local to one of the client machines. Data may be entered into at least one field in the service application through the browser. Instructions are provided to encrypt the entered data in the browser on one of the client machines with a public key, and to transmit the data to the server following the encryption of the data. Following receipt of the encrypted data from the server on one of the client machines, instructions are provided to decrypt the received encrypted data with a private key local to one of the client machines in receipt of the data.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a prior art block diagram of a computer system with multiple client machines in communication with a server across a network.

FIG. 2 is a flow chart illustrating encryption of data entered into a web service account stored on a server according to the preferred embodiment of this invention, and is suggested for printing on the first page of the issued patent.

FIG. 3 is a flow chart illustrating a process for viewing previously encrypted data that is stored on a remote server.

FIG. 4 is a block diagram illustrating a data encryption tool in a computer system.

### DESCRIPTION OF THE PREFERRED EMBODIMENT

### Overview

Web service applications are form based applications that reside on a server and are accessible to a client machine by a browser application on the client machine. A user of the web service application can enter data into the form fields of the service and encrypt the entered data with a public key. The same or a different user may access the same form of the service application to access and/or view the encrypted data. A private key owned by the user accessing the encrypted data is required to decrypt and view the data. Accordingly, an encryption tool is applied to a web service application wherein the encrypted data is saved on a server machine in communication with the browser of the client machine.

### Technical Details

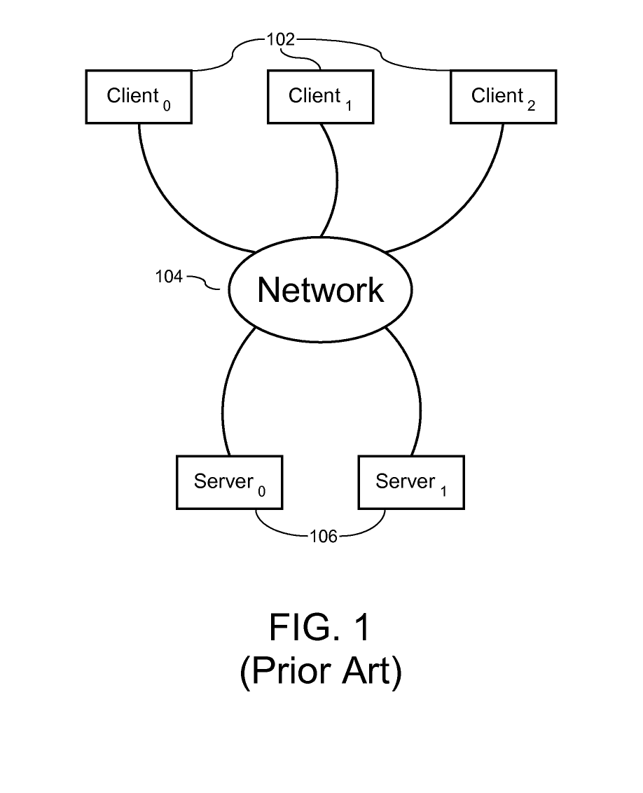

Referring to the drawings, FIG. 1 illustrates an exemplary prior art network environment in which the present invention may be utilized. In FIG. 1, one or more client machines (102) are coupled to a data communication network (104). In one embodiment, the network (104) is a distributed wide area network, such as the Internet. However, the teachings of the present invention should not be limited to the Internet and can be applied to any data communication network, such as a local area network. Multiple servers (106) are shown coupled to the network (104). In one embodiment, the servers (106) may be referred to as web servers. One or more client machines (102) can access servers (106) via the network (104). In one embodiment, the client machines (102) and the servers (106) communicate data among themselves using the hypertext transfer protocol (HTTP), a protocol commonly used on the Internet to exchange information.

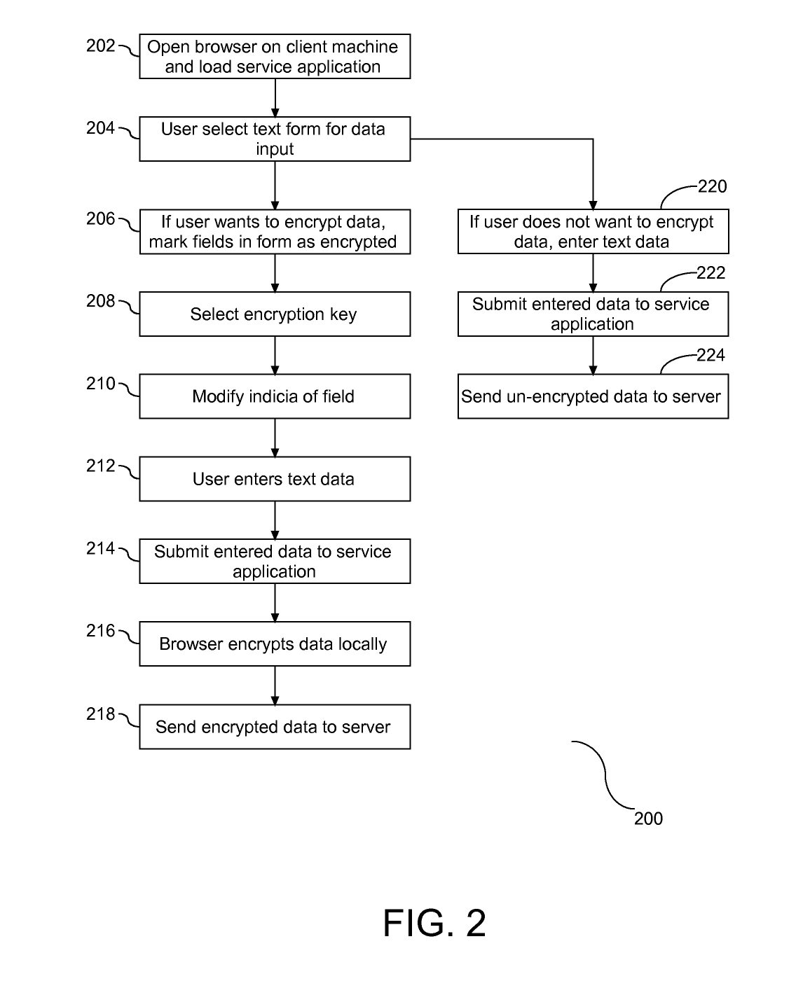

A user may employ an input device through a client machine in communication with the network to enter data into one or more fields of a supported service application. Web based form filled service applications enable users to utilize software tools that are stored and maintained on a server remote from a client machine. Such applications have become widely used and accepted in different formats. For example, web mail is a service application that enables users to send and receive electronic mail from any client machine in communication with the server hosting the service application. A user establishes an account with the server and associated service application, and the server stores data in the account. FIG. 2 is a flow chart (200) illustrating the encryption of data input and stored in the associated web service account. Initially, a user opens a browser on the client machine and loads a service application (202). In one embodiment, the application is a form based application that is configured to receive data input in the form, such as a calendar, clock, bookmark manager, web mail, etc. After opening the service application(s), the user selects a text form for data input (204).

Once the form has been selected and prior to data entry, if the user wants the data encrypted, one or more fields in the form are marked as encrypted (206). In one embodiment, the field is marked by selection of a command on the browser supporting the application, or through an input device. For example, marking of the field at step (206) may minimally require depression of a button on the right side of a mouse or trackball, also known in the field as a right click. Following step (206), a key is selected for use in encryption of data to be entered (208). Once the key has been selected at step (208), indicia of the field(s) selected to receive the data sought to be encrypted is modified to denote encryption thereof (210). A browser extension is provided to extend the functionality of the browser to enhance the browser view to support and accept encryption of data. More specifically, the browser extension manages encryption and decryption of data. In one embodiment, a browser extension in the form of a module, application, or script that extends a browser's functionality is employed. The browser extension is integrated with browser and it enables text to be passed to an encryption program, which encrypts the data and at a later time returns the data while supporting the encryption. In one embodiment, the encryption of the data may be performed through an external application, wherein the browser extension enhances the browser view that accepts encryption while the external application performs encryption of data in the background, i.e. the browser provides the user interface while the external application executes code to encrypt text. In one embodiment, the modification may be in the form of shading the field(s), or otherwise applying a different background to the field(s) in the form of a different color or different pattern. Similarly, in one embodiment, a lock icon may be displayed somewhere on a visual display in communication with the client machine to denote encryption of data to be entered into the field(s). The purpose of the modification of the field is to communicate in a visual manner that data to be entered into the marked field is intended to be encrypted. Accordingly, prior to entry of text into the field(s) of the application, the intention to encrypt the data is determined.

Following step (210), the selected service application is ready to receive and encrypt data into the field(s). The user enters the text data (212). When the user has completed the data entry, the user submits the entered data to the service application (214). In one embodiment, the service application includes a submit button, or the equivalent thereof, to communicate entered data to a server that supports the service application. Prior to communicating the data to the server, the browser application local to the client machine locally encrypts the form data (216). In one embodiment, the encryption may include addition of a special header to the form data wherein the header may be embedded within the encrypted text content of the service application when the data in the text content is encrypted by the user. The header functions as a notification tool to communicate a state of encryption of the data within the content field to a receiving browser. Once the local encryption at step (216) is completed, the browser on the local client machine sends the encrypted text to the server supporting the service application (218). Accordingly, encryption of the data entered on the browser of the local client machine is encrypted locally on the client machine and is stored remotely on the server supporting the service application, or on storage media in communication with the server application.

As shown following step (204), the user may determine that they do not want to encrypt data to be entered. The user enters text data into the select fields (220). When the user has completed the data entry at step (220), the user submits the entered data to the service application (222). In one embodiment, the service application includes a submit button, or the equivalent thereof, to communicate entered data to a server that supports the service application. Following step (222), the browser local to the client machine sends the entered and unencrypted data to the server supporting the service application (224). Accordingly, although encryption of data may be available, the user does not have to encrypt data to be entered.

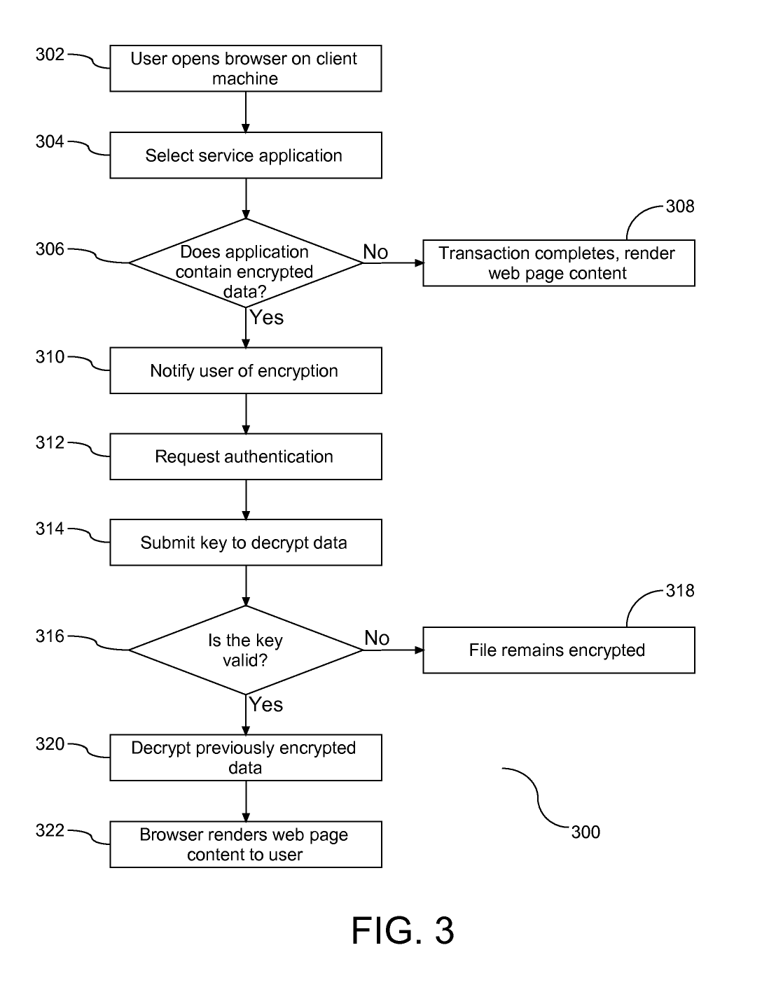

The encryption tool employed herein to encrypt the data entry is hosted by the browser on the client machine and is separate from the server hosting the service application. In one embodiment, the data entered into a browser hosting a service application may be encrypted with a browser owned public key. The entered data is stored on the server hosting the service application or storage media in communication with the hosting server. Regardless of the structure, the data entered is not stored on the client machine. The same user can log on to a different client machine, proceed through the authentication process, and attempt to view the previously entered and encrypted data. Similarly, in the case of a service application providing electronic mail communication(s) a different user can log on to the same client machine or a different client machine to receive a message with encrypted data from the sender. Regardless of the service application, the form data may be encrypted for viewing by the same user or a different authorized user on the same client machine or a different client machine. Until the data is decrypted with a valid key, it will remain encrypted and unintelligible as illustrated in further detail in FIG. 3 below. Accordingly, it is the behavior of the browser local to the client machines that is modified with employment of a browser extension to support data encryption. Accordingly, the behavior of the browser is modified to support the data encryption.

FIG. 3 is a flow chart (300) illustrating a process for viewing previously encrypted data that was sent to a server or storage media in communication with the server hosting a service application. Initially, a user opens a browser on the client machine (302) and selects a service application in which they have an account or want to establish an account (304). In one embodiment, the user may not have established an account, wherein the user would enter the location to set up an account with user identification and an associated password that would later be used for authentication in order to enter the account. Once the user has been authenticated with the proper identifier and password, the user may select one or more service applications available. Similarly, in one embodiment, the user may have an established account that requires user authentication prior to entry into the account. The service application is hosted on a remote server. As the web page from the selected service is being loaded onto the client machine, the browser local to the client machine determines if the web page being loaded contains encrypted data (306). In one embodiment, the browser extension in browser searches for a header in one or more fields of the web page as the web page is being rendered from the server to the client machine. The headers in this embodiment would server as an indicator of encryption. A negative response to the determination at step (306) enables the transaction to complete and for the browser local to the client machine to render the web page content (310). However, if it is determined at step (308) that the web page being loaded contains encrypted data, the browser notifies the user of the client machine of the encryption (310), and requests authentication of the user to decrypt the encrypted data (312). For example, in one embodiment, the user may need to submit a private key to the browser to decrypt the encrypted data. Similarly, in one embodiment, a browser extension is employed to decrypt the previously encrypted data. A browser extension is a module, application, or script that extends a browser's functionality. Following submission of a key or an alternate decryption tool to decrypt the data (314), it is determined if the key submitted is valid (316). As is known in the art, a private key or a public key is distributed with discretion and maintained on a recordable data storage media local to the client machine. If it is determined that the key to decrypt the data is not valid, the text content remains encrypted (318). Alternatively, if it is determined that the key submitted at step (316) is valid, the previously encrypted data is decrypted (320), followed by the browser rendering the web page content to the user (322).

As noted above, in one embodiment, a header may be embedded within the encrypted text content of the service application when the data in the text content is encrypted by the user. The user may employ one browser for data entry and encryption and a second browser to view the encrypted data, or the user may employ the same browser for entry and viewing at a later time. Regardless of the quantity of browsers employed, the header of the encrypted text content attaches to the file directly. It is embedded in the file by the browser. The header functions as a notification tool of the encryption. At such time as the user selects to open an encrypted file, the browser requests the file from the server. Upon receipt of the requested file, the browser parses the file. In one embodiment, the browser extension that supports the data encryption has parsing capability. The browser extension watches the data stream and modifies the data stream as the page is being rendered. When the browser extension notices the header in the stream, the extension tries to decrypt the data following the header. The header only pertains to the encrypted portion of a field. Each text field that is encrypted will include a separate header. Once a header is detected by the browser extension, the user will then be prompted to enter a password associated with their private key to authenticate their possession of the key.

In one embodiment, the invention is implemented in software, which includes but is not limited to firmware, resident software, microcode, etc. The invention can take the form of a computer program product accessible from a computer-usable or computer-readable medium providing program code for use by or in connection with a computer or any instruction execution system. For purposes of this description, a computer-usable or computer readable medium can be any apparatus that can contain, store, communicate, propagate, or transport the program for use by or in connection with the instruction execution system, apparatus, or device.

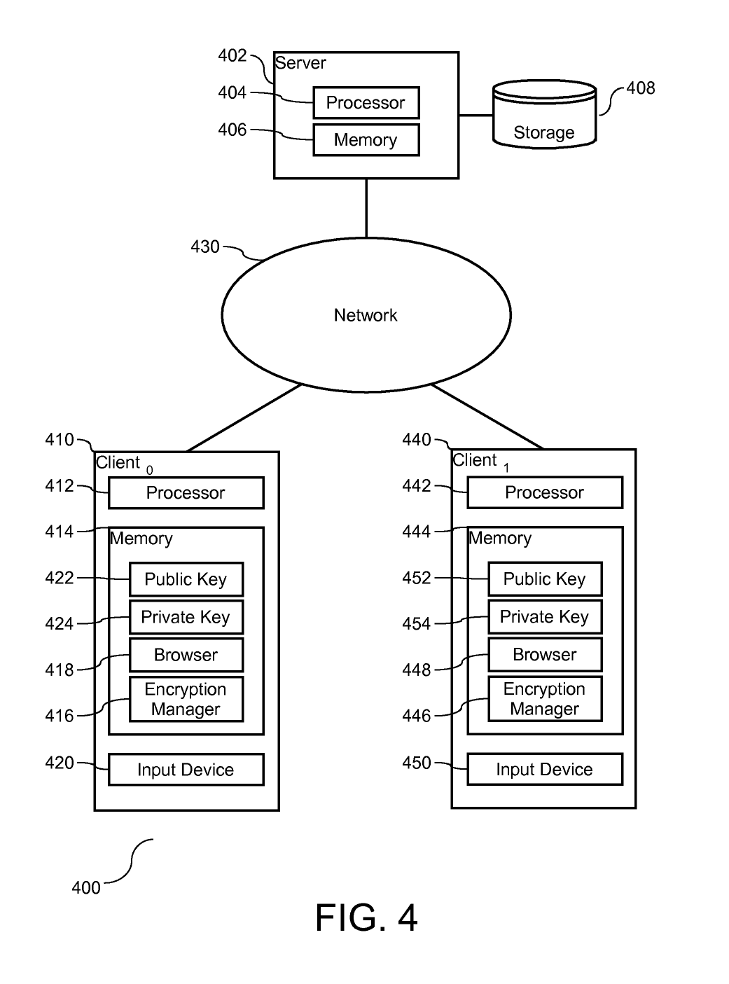

FIG. 4 is a block diagram (400) illustrating a data encryption tool in a computer system. The illustration shows a server machine (402) with a processor (404) and memory (406). The server machine (402) is shown in communication with two client machines (410) and (440) across a network (430). The invention should not be limited to the quantity of server machines and client machines shown herein. In one embodiment, the system may include a plurality of server machines and one or more client machines. For illustrative purposes, the following description will be applied to two client machines, but may be extrapolated for any client machine in communication with the network (430). The client machine (410) includes a processor (412), memory (414), an encryption manager (416) embedded within the memory (414), a browser application (418), and an input device (420) to support input of data to the browser application (418). Similarly, a client machine (440) includes a processor (442), memory (444), an encryption manager (446) embedded within the memory (444), a browser application (448), and an input device (450) to support input of data to the browser application (448). The browser application (418) and (448) is a software application used to locate and display web pages that are stored on the server (402) or in storage media (408) in communication with the server. The client encryption managers (416) and (446) encrypt data entered into the respective browser on one of the client machines. In one embodiment, the client encryption manager is in the form of a browser extension. A public key (422) resides in memory (414) of client machine (410), and a public key (452) resides in memory (444) of client machine (440). Public and private keys require both to work. Each public key is one half of a cryptographic system that uses two keys to encrypt data. The keys are linked together with one of the keys kept private, i.e. private key, and the other key shared, i.e. public key. In one embodiment, public keys are shared through transmission of the key across a network to a designated recipient. When a holder of a public key wants to forward encrypted data, they employ the public key for the encryption, and the recipient employs the private key to the public key employed for the encryption. Similarly, each client machine that is configured to receive and decrypt encrypted data will require a private key, which is a complementary key to the public key that is known only to the recipient or intended recipient of the encrypted data. In the example shown herein, private key (424) resides in memory (414) of client machine (410), and private key (454) resides in memory (444) of client machines (440). Accordingly, each of the client machines in this example includes both a private key and a public key.

For data that is entered in client machine (410), the encryption manager (416) encrypts the data entered in the browser application (418) with public key (422). Similarly, for data that is entered in client machine (440), the encryption manager (446) encrypts the data entered in the browser application (448) with public key (452). At such time as the same user on the same or different client machine wants to access the encrypted data, or a different user on the same or different client machines wants to access the encrypted data, that client machine must have the private key (424), (454) that is related to the public key used to encrypt the data. The encryption manager of the client machine in receipt of the file containing the encrypted data decrypts the received encrypted data with a private key associated with the encryption public key local to the client machine.

The encryption managers (416) and (446) may reside in memory (414) and (444), respectively, as shown, and utilize instructions in a computer readable medium to encrypt data with a public key. Similarly, in one embodiment, the managers (416) and (446) may reside as hardware tools external to memory (416) and (446), respectively, or they may be implemented as a combination of hardware and software in the client machines (410) and (440), respectively. Accordingly, the managers (416) and (446) may be implemented as a software tool or a hardware tool to facilitate encryption of data in a web service application.

Embodiments within the scope of the present invention also include articles of manufacture comprising program storage means having encoded therein program code. Such program storage means can be any available media which can be accessed by a general purpose or special purpose computer. By way of example, and not limitation, such program storage means can include RAM, ROM, EPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include but are not limited to a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code includes at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks.

The software implementation can take the form of a computer program product accessible from a computer-useable or computer-readable medium providing program code for use by or in connection with a computer or any instruction execution system.

### Advantages Over The Prior Art

Data entered with use of a web service application is encrypted on the client machines and not in the web application resident to the server. End to end encryption is provided from one client machine to a second client machine by encrypting form and text fields using a public key private key encryption system. Web service applications and infrastructure can be utilized while maintaining the confidentiality and integrity of the data therein. However, the advantages are not limited to a tool to render purposefully embedded content. In one embodiment, the tool modifies how the browser behaves and parses text content. Accordingly, the tool both renders encrypted content and/or modifies the behavior of the browser to parse the text content.

### Alternative Embodiments

It will be appreciated that, although specific embodiments of the invention have been described herein for purposes of illustration, various modifications may be made without departing from the spirit and scope of the invention. In particular, an extension to the browser operating on the client machine may be provided, wherein the extension would enable encryption on a form by form basis by selecting a menu option on the browser. When entering text in an encrypted form, the non-encrypted text is visible on an associated visual display. On any action that would send the form text to the server, the browser of the client machine used to input the data would encrypt the text with a public key before transmission to the server. At the time the browser of a client machine in receipt of the encrypted file may employ a browser extension to detect the header in the encrypted text. The browser would then notify the user that they need to provide a password for their private key in order to decrypt the text content. Upon entry of a correct private key password, the decrypted text would be displayed by the browser on the visual display.

In addition, the server application may come in different formats wherein the user inputs data into a form. In one embodiment, the service application may be a web service application in the form of a browser plug-in, such as a calendar, clock, bookmark manager, web mail, etc. After opening the service application(s), the user may enter text and or other data into the application through an input device. Similarly, the service application may be a web mail application wherein the data input is form entry and the data is stored remotely on the server or data storage in communication with the server. Accordingly, the scope of protection of this invention is limited only by the following claims and their equivalents.

We claim:

1. A method for encrypting data comprising:
accessing a service application supported by a server machine through a browser local to at least one client machines;
entering data into at least one field in said service application through said browser;
encrypting the entered data in the browser on one of said client machines;
transmitting the encrypted data to the server;
receiving the encrypted data from the server on one of said client machines; and
decrypting the received encrypted data local to one of said client machines in receipt of said data.

2. The method of claim 1, further comprising embedding a header into a field of a browser page with said transmitted encrypted data to communicate a state of encryption of said data in said field to a receiving browser.

3. The method of claim 2, further comprising receiving the browser page with the embedded header associated with the encrypted data, and wherein the step of decrypting the received encrypted data includes detecting form data with said header specifying encryption of said received data.

4. The method of claim 3, further comprising employing a decryption tool local to said client machine in receipt of said encrypted data to decrypt said received data.

5. The method of claim 1, wherein the step of decrypting said received encrypted data includes authentication of a private key.

6. The method of claim 1, wherein said service application includes a web application in the form of electronic mail, calendar, and other tools that employ form field data.

7. A computer system comprising:
at least one client machine in communication with at least one server machine across a network;
a service application supported by said at least one server machine;
a browser operable on said at least one client machine;
said service application accessible through said browser;
an input device to communicate with said browser and to enter data into at least one field in said service application through said browser;
a transmission encryption manager to encrypt said entered data in the browser on one of said client machines;
one of said client machines to receive the encrypted data from the server machine; and
a recipient encryption manager to decrypt the received encrypted data with a tool local to said client machine in receipt of said data.

8. The system of claim 7, further comprising a header embedded into a field of a browser page with said transmitted encrypted data to communicate a state of encryption of said data to a browser on a client machine in receipt of said data.

9. The system of claim 8, wherein receipt of the embedded header with the encrypted data includes said recipient encryption manager to detect form data with said header specifying encryption of said received data.

10. The system of claim 9, further comprising a decryption tool local to a recipient client machines to decrypt said received data.

11. The system of claim 7, wherein decryption of the received encrypted data by said encryption manager includes authentication of a private key.

12. The system of claim 7, wherein said service application includes a web application in the form of electronic mail, calendar, and other tools that employ form field data.

13. An article comprising:
a computer readable carrier including computer program instructions configured to encrypt data, said instructions comprising:
instructions to configure a distributed computer system with at least one client machine in communication with at least one server machine across a network and to access a service application supported by said server machine through a browser local to one of said client machines;
instructions to enter data into at least one field in said service application through said browser;
instructions to encrypt the entered data in the browser on one of said client machines;
instructions to transmit the encrypted data to the server;
instructions to receive the encrypted data from the server on one of said client machines; and
instructions to decrypt the received encrypted data local to one of said client machines in receipt of said data.

14. The article of claim 13, further comprising instructions to embed a header into a field of a browser page with the embedded header associated with the encrypted data to communicate a state of encryption of said data in said field to a receiving browser.

15. The article of claim 14, further comprising instruction to receive the browser page with the embedded header associated with the encrypted data, and wherein the instructions to decrypt the received encrypted data includes detecting form data with said header specifying encryption of said received data.

16. The article of claim 15, further comprising instructions to employ a browser extension local to said client machine in receipt of said encrypted data to decrypt said received data.

17. The article of claim 13, wherein the instructions to decrypt said received encrypted data includes authentication of a private key.

18. The article of claim 13, wherein said service application includes a web application in the form of electronic mail, calendar, and other tools that employ form field data.
